(19) United States
(12) Patent Application Publication
(10) Pub. No.: US 2023/0307196 A1
(43) Pub. Date: Sep. 28, 2023

(54) KEY MODULE AND KEYBOARD

(71) Applicant: Lite-On Technology Corporation, Taipei (TW)

(72) Inventors: Cheng-Kun Liao, Taipei (TW); Ming-Fu Yen, Taipei (TW); Cheng-Hsiung Huang, Taipei (TW)

(73) Assignee: Lite-On Technology Corporation, Taipei (TW)

(21) Appl. No.: 18/188,480

(22) Filed: Mar. 23, 2023

Related U.S. Application Data
(60) Provisional application No. 63/322,651, filed on Mar. 23, 2022.
(60) Provisional application No. 63/348,022, filed on Jun. 2, 2022.
(60) Provisional application No. 63/391,807, filed on Jul. 25, 2022.

(51) Int. Cl. H01H 13/83; H01H 13/14; H01H 13/20; H01H 13/02; G02F 1/1677

(52) U.S. Cl. CPC H01H 13/83; H01H 13/14; H01H 13/20; H01H 13/023; G02F 1/1677

(57) ABSTRACT

A key module and a keyboard are disclosed. The key module includes a bottom plate including a first opening; a keycap disposed on the bottom plate, and including a visible region corresponding to the first opening; a flexible component disposed between the bottom plate and the keycap, and including a second opening corresponding to the visible region; a support structure connected between the bottom plate and the flexible component, and including a third opening corresponding to the visible region; a circuit layer disposed between the bottom plate and the flexible component, and including a fourth opening corresponding to the visible region; and a pattern modulator disposed below the bottom plate, and including a pattern region corresponding to the visible region.

### CROSS-REFERENCE TO RELATED APPLICATION

This application claims the priority benefits of U.S. provisional application Ser. No. 63/322,651, filed on Mar. 23, 2022, U.S. provisional application Ser. No. 63/348,022, filed on Jun. 2, 2022, and U.S. provisional application Ser. No. 63/391,807, filed on Jul. 25, 2022. The entirety of each of the above-mentioned patent applications is hereby incorporated by reference herein and made a part of this specification.

### BACKGROUND

### Technical Field

The disclosure relates to a key module and a keyboard. In particular, the disclosure relates to a variable-pattern-type key module and a keyboard including the variable-pattern-type key module.

### Description of Related Art

At present, characters or patterns on keys of a keyboard are typically printed characters or patterns, or the characters or patterns are formed by spraying on surfaces of keycaps and then laser engraving. However, such a design cannot realize arbitrary and rapid changes of the characters or patterns on the keys. If it is required to change the character or pattern of a key, such a requirement can be met only by replacing the entire keycap, which is relatively inconvenient for a user.

### SUMMARY

The disclosure is directed to a key module, which changes different patterns to be displayed.

The disclosure is directed to a keyboard, including the above-mentioned key module.

According to an embodiment of the disclosure, a key module includes a bottom plate, a keycap, a flexible component, a support structure, a circuit layer, and a pattern modulator. The bottom plate includes a first opening. The keycap is disposed on the bottom plate, and includes a visible region corresponding to the first opening. The flexible component is deformably disposed between the bottom plate and the keycap, and includes a second opening corresponding to the visible region. The support structure is connected between the bottom plate and the flexible component, and includes a third opening corresponding to the visible region. The circuit layer is disposed between the bottom plate and the flexible component, and includes a fourth opening corresponding to the visible region. The pattern modulator is disposed below the bottom plate, and includes a pattern region corresponding to the visible region. The pattern region is exposed by the first opening, the fourth opening, the third opening, and the second opening.

In the key module according to an embodiment of the disclosure, the pattern modulator includes an electronic paper component, and the electronic paper component includes the pattern region corresponding to the visible region.

In the key module according to an embodiment of the disclosure, the pattern modulator further includes a backlight component. The backlight component is disposed between the electronic paper component and the bottom plate. Light emitted by the backlight component illuminates the pattern region.

In the key module according to an embodiment of the disclosure, the circuit layer includes at least one trigger switch region. The flexible component includes at least one pressing portion corresponding to the at least one trigger switch region. Projections of the at least one trigger switch region and the at least one pressing portion on the electronic paper component are located outside the pattern region.

In the key module according to an embodiment of the disclosure, the at least one trigger switch region includes a plurality of trigger switch regions, symmetrically disposed beside the fourth opening. The at least one pressing portion includes a plurality of pressing portions, symmetrically disposed beside the second opening.

In the key module according to an embodiment of the disclosure, the plurality of pressing portions are disposed at four corners of the second opening.

In the key module according to an embodiment of the disclosure, a light emitting component and a light receiving component facing each other are disposed in the circuit layer. The key module further includes a blocking portion linked with the keycap. The blocking portion is movably inserted between the light emitting component and the light receiving component. Projections of the light emitting component, the light receiving component, and the blocking portion on the electronic paper component are located outside the pattern region.

In the key module according to an embodiment of the disclosure, the flexible component includes a flexible body and a rigid member bonded to the flexible body. The blocking portion is formed at the flexible body.

In the key module according to an embodiment of the disclosure, the flexible component includes a flexible body and a rigid member bonded to the flexible body. The blocking portion is formed at the rigid member.

In the key module according to an embodiment of the disclosure, the blocking portion is formed at the support structure.

In the key module according to an embodiment of the disclosure, the blocking portion is formed at the keycap, and the blocking portion is opaque.

In the key module according to an embodiment of the disclosure, the flexible component includes a flexible body and a rigid member bonded to the flexible body. The support structure includes a plurality of shafts. A part of the plurality of shafts are connected to the bottom plate. Another part of the plurality of shafts are connected to the rigid member. The pattern region is rectangular and includes a first edge and a second edge opposite to each other and a third edge and a fourth edge opposite to each other. The plurality of shafts protrude from the first edge and the second edge. The light emitting component and the light receiving component are located at the third edge or the fourth edge.

In the key module according to an embodiment of the disclosure, the flexible component includes a flexible body and a rigid member bonded to the flexible body. The keycap is attached to the flexible body.

In the key module according to an embodiment of the disclosure, the flexible component includes a flexible body and a rigid member bonded to the flexible body. The keycap is attached to the rigid member.

In the key module according to an embodiment of the disclosure, the flexible component includes a flexible body and a rigid member bonded to the flexible body. The support structure includes a first connecting member and a second connecting member connected to the first connecting member. The first connecting member and the second connecting member include a plurality of shafts. A part of the plurality of shafts are connected to the bottom plate. Another part of the plurality of shafts are connected to the rigid member.

In the key module according to an embodiment of the disclosure, the pattern region is rectangular and includes a first edge and a second edge opposite to each other and a third edge and a fourth edge opposite to each other. The plurality of shafts protrude from the first edge and the second edge. The circuit layer includes at least one trigger switch region. The at least one trigger switch region corresponds to at least one of the third edge and the fourth edge.

In the key module according to an embodiment of the disclosure, the bottom plate includes a flat body and two fixing elements. The two fixing elements are bent from the flat body and protruding from the flat body, and connected to two of the plurality of shafts.

In the key module according to an embodiment of the disclosure, the bottom plate includes a flat body and two fixing elements. The flat body includes two opening grooves. The two fixing elements are filled in the two opening grooves and engaged with the flat body. One of the two fixing elements includes a slot and a stopping portion. One of the plurality of shafts slides into the slot and is stopped by the stopping portion. The other one of the two fixing elements includes two opposite bosses. The two bosses each have an inclined guide surface and surroundingly form a circular slot. Another one of the plurality of shafts enters the circular slot along the inclined guide surfaces and is fixed.

In the key module according to an embodiment of the disclosure, the bottom plate includes two protrusions located beside the two opening grooves and protruding from the flat body. The protrusion and the flat body surroundingly form the corresponding opening groove. The fixing element wraps the corresponding protrusion.

In the key module according to an embodiment of the disclosure, the protrusion has a hole, and the fixing element is filled in the hole.

In the key module according to an embodiment of the disclosure, the protrusion has two bent portions. Each of the two bent portions partially extends in a direction away from the flat body. The fixing element wraps the two bent portions.

According to an embodiment of the disclosure, a keyboard includes the above-mentioned key module and another key module. The another key module includes a second keycap.

The first key module of the embodiment of the disclosure includes a bottom plate, a keycap, a flexible component, a support structure, a circuit layer, an electronic paper component, and a backlight component. Light emitted by the backlight component illuminates the pattern region of the electronic paper component. The pattern region is exposed by the first opening of the bottom plate, the fourth opening of the circuit layer, the third opening of the support structure, and the second opening of the flexible component, and may be viewed from the visible region of the keycap. Since the pattern region of the electronic paper component may change different patterns to be displayed in real time, without replacing the keycap, the user can change the pattern of the first key module quickly and arbitrarily, which is relatively convenient and flexible in use, and cost-saving.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of a keyboard according to an embodiment of the disclosure.

FIG. 1B is a schematic perspective view of a second key module of FIG. 1A.

FIG. 2A is a schematic perspective view of a first key module of FIG. 1A.

FIG. 2B is an exploded view of the first key module of FIG. 1A.

FIG. 2C is a schematic cross-sectional view of the first key module of FIG. 1A.

FIG. 3 is a schematic top view of the first key module of FIG. 1A.

FIG. 4 is a schematic partial perspective cross-sectional view of the first key module of FIG. 3 along section line A-A.

FIG. 5A is a schematic top view of a first key module according to another embodiment of the disclosure.

FIG. 5B is a schematic partial perspective cross-sectional view of the first key module of FIG. 5A along section line B-B.

FIG. 6A is a schematic top view of a first key module according to another embodiment of the disclosure.

FIG. 6B is a schematic partial perspective cross-sectional view of the first key module of FIG. 6A along section line C-C.

FIG. 7 is a schematic partial perspective cross-sectional view of a first key module according to another embodiment of the disclosure.

FIG. 8 is a schematic partial perspective cross-sectional view of a first key module according to another embodiment of the disclosure.

FIG. 9 is a schematic partial perspective cross-sectional view of a first key module according to another embodiment of the disclosure.

FIG. 10 is a schematic cross-sectional view of a first key module according to another embodiment of the disclosure.

FIG. 11 is a schematic perspective view of a support structure and a bottom plate of the first key module of FIG. 10.

FIG. 12 is a schematic cross-sectional view of a first key module according to another embodiment of the disclosure.

FIG. 13A is a schematic partial perspective view of a support structure and a bottom plate of the first key module of FIG. 12.

FIG. 13B is another schematic partial perspective view of the support structure and the bottom plate of the first key module of FIG. 12.

FIG. 14A is a schematic partial top view of the bottom plate of the first key module of FIG. 12.

FIG. 14B is a schematic partial cross-sectional view of the first key module of FIG. 14A along section line F1-F1.

FIG. 14C is a schematic partial perspective view of the first key module of FIG. 14A.

FIG. 15A is a schematic partial top view of a bottom plate of a first key module according to another embodiment of the disclosure.

FIG. 15B is a schematic partial cross-sectional view of the first key module of FIG. 15A along section line F2-F2.

FIG. 16A is a schematic partial top view of a bottom plate of a first key module according to another embodiment of the disclosure.

FIG. 16B is a schematic partial cross-sectional view of the first key module of FIG. 16A along section line F3-F3.

FIG. 17A is a schematic perspective view of a first key module according to another embodiment of the disclosure.

FIG. 17B is an exploded view of the first key module of FIG. 17A.

FIG. 18 is a schematic perspective view of a first key module according to another embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numerals are used in the drawings and descriptions to refer to the same or like parts.

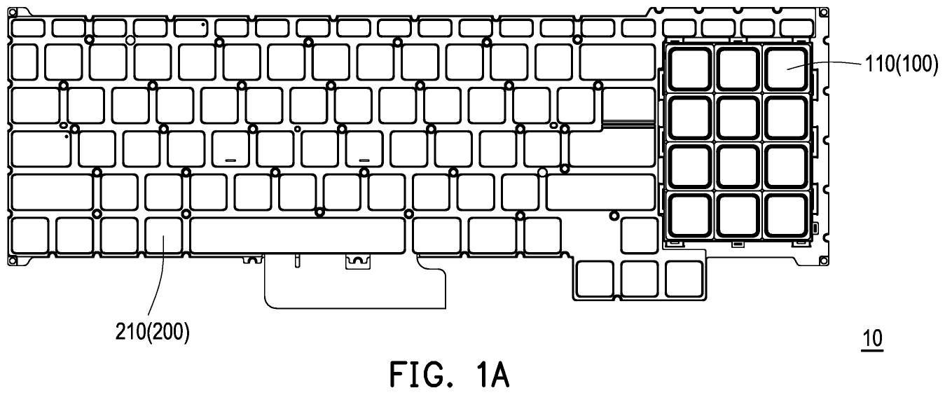

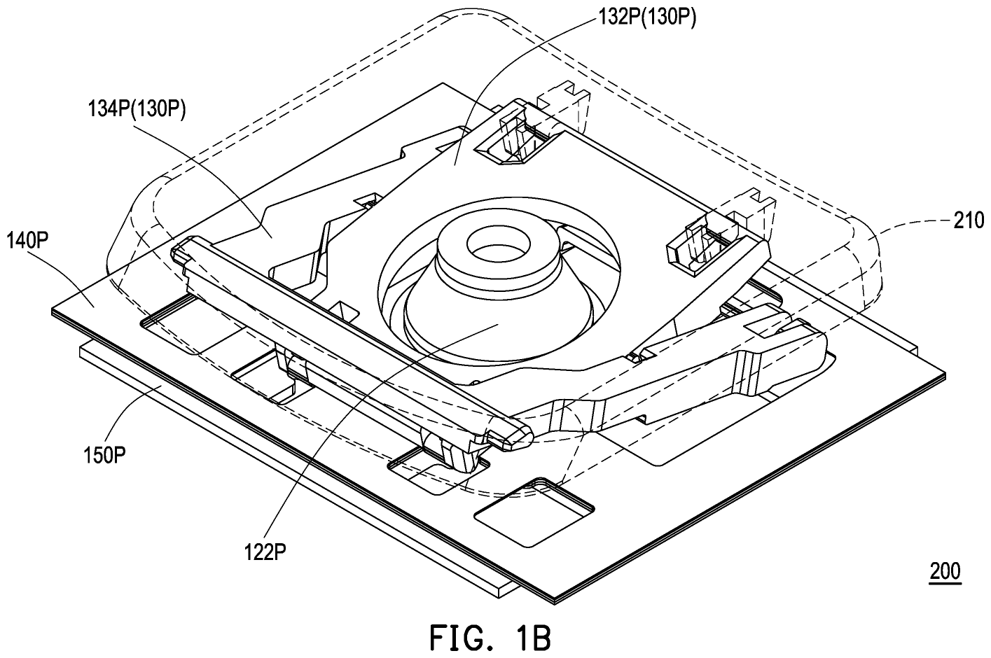

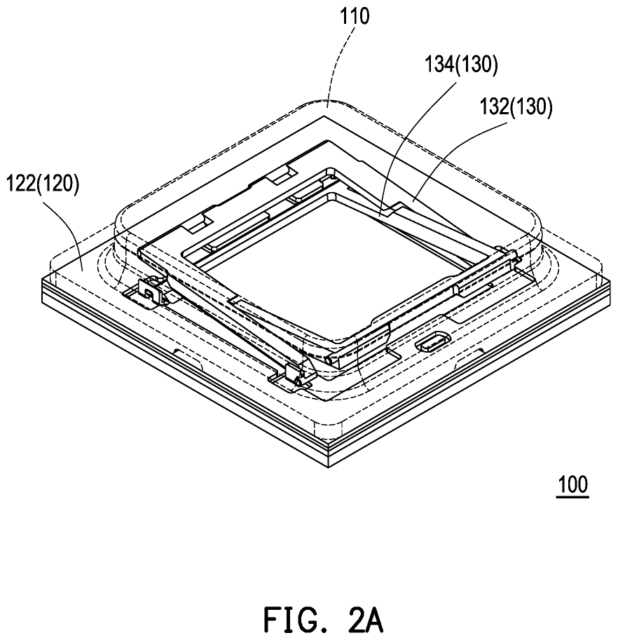

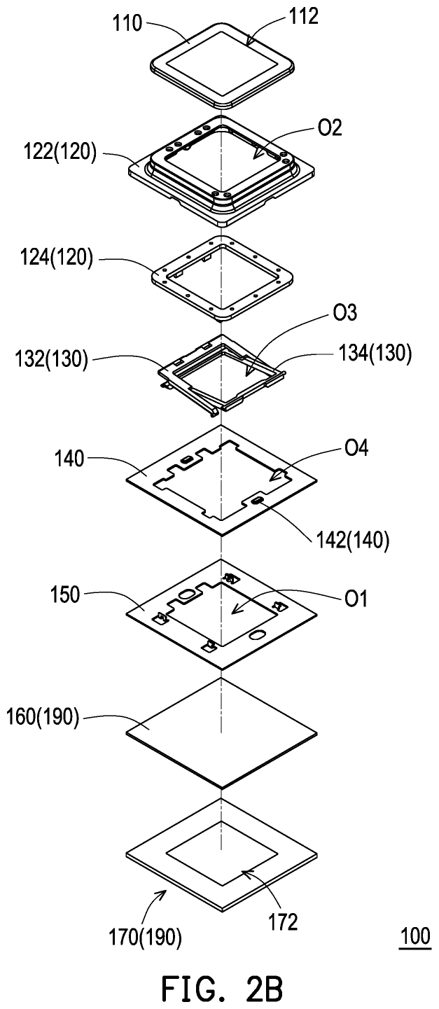

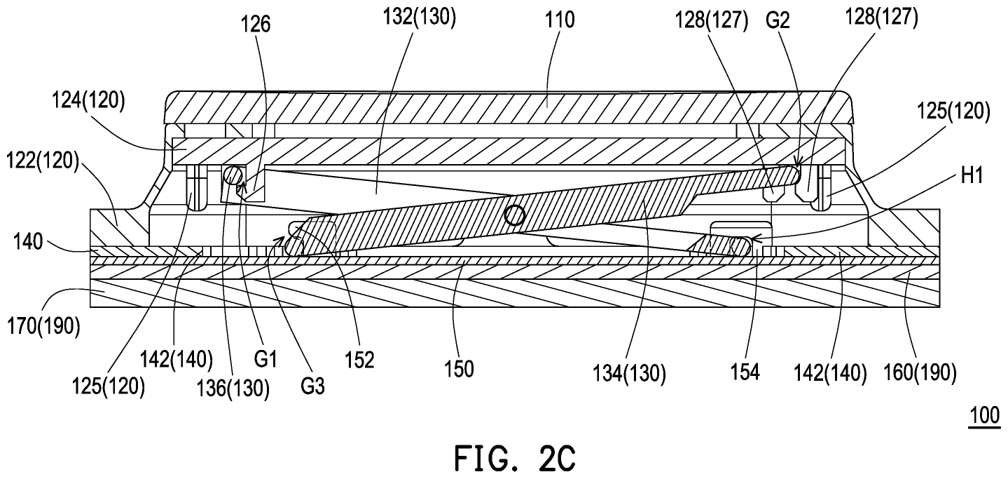

FIG. 1A is a schematic view of a keyboard according to an embodiment of the disclosure. FIG. 1B is a schematic perspective view of a second key module of FIG. 1A. FIG. 2A is a schematic perspective view of a first key module of FIG. 1A. It should be noted that the keycap, the flexible component, and the rigid member in FIG. 2A are shown with broken lines. With reference to FIGS. 1A and 2A, in this embodiment, a keyboard 10 includes a first key module 100 and a second key module 200. The first key module 100 and second keycap 210 be different. For example, the first key module 100 may be a variable-pattern-type key module, and the second key module 200 may be a printed key module. As shown in FIG. 1B, the second key module 200 includes a second keycap 210, e.g., a printed character keycap. Characters are, for example, formed on the surface of the second keycap 210 by printing specific patterns; or characters are formed by first spraying or painting a layer on the surface of the second keycap 210 and then laser engraving the layer to get specific patterns. However, forming characters of the printed character keycap 210 is not limited thereto. While the second keycap 210 has a pattern or character formed thereon, the second keycap 210 may further include a lighting component disposed below the second keycap 210 to illuminate the pattern or character.

The second key module 200 further includes a circuit layer 140P, a bottom plate 150P, a flexible component 122P, and a support structure 130P. The second keycap 210 is disposed above the bottom plate 150P. The circuit layer 140P is disposed on the bottom plate 150P. The support structure 130P includes a first connecting member 132P and a second connecting member 134P connected to each other, and is disposed between the second keycap 210 and the circuit layer 140P. The first connecting member 132P could be disposed in an aperture defined by the second connecting member 134P and pivotally connected to the inner side of the second connecting member 134P. In this embodiment, the first connecting member 132P is provided with an aperture, so that the connecting members 132P and 134P jointly define an aperture of the support structure 130P. In this embodiment, the support structure 130P may be made of plastics. The flexible component 122P passes through the aperture of the support structure 130P and is disposed between the second keycap 210 and the circuit layer 140P. When a user presses the second keycap 210, the flexible component 122P may deform correspondingly and trigger the switch of the circuit layer 140P. When the force pressing the circuit layer 140P downward disappears, the flexible component 122P releases the elastic potential energy and lifts the second keycap 210. The support structure 130P serves to ensure that the second keycap 210 is kept horizontal when being pressed downward and lifted upward horizontally.

In this embodiment, the first key module 100 includes a plurality of first key modules disposed on the keyboard 10, but the application and number of the first key module 100 are not limited thereto. The first key module 100 serves to display an electronic pattern, and may allow the user to change the pattern depending on requirements, which is relatively quick and convenient. One first key module 100 will be taken as representative for description in detail below.

FIG. 2B is an exploded view of the first key module of FIG. 1A. FIG. 2C is a schematic cross-sectional view of the first key module of FIG. 1A. In order to clearly present the internal structure of the first key module, the third fixing element, the fourth fixing element, and the part of the shaft blocked by the support structure are shown with broken lines in FIG. 2C. With reference to FIG. 2B and FIG. 2C, the first key module 100 includes a bottom plate 150, a keycap 110, a flexible component 120, a support structure 130, a circuit layer 140, and a pattern modulator 190. In this embodiment, the bottom plate 150 is made of metal and includes a first opening 01. The keycap 110 is disposed on the bottom plate 150 and includes a visible region 112 corresponding to the first opening 01. The keycap 110 is made of a transparent material, for example, for the user to view the interior of the first key module 100 from the visible region 112 of the keycap 110.

It is required to reserve the space and structure at least for connection with the flexible component 120 or the support structure 130 at an edge of the keycap 110. Taking a normal key whose length and width are substantially equal as an example of the keycap 110, the length or width of the visible region 112 occupies at least 50% of the corresponding length or width of the keycap 110, and the area of the visible region 112 occupies at least 35% of the overall area of the top surface of the keycap 110, for the user to identify the pattern transmitted from the interior. In an embodiment, the length or width of the visible region 112 occupies at least 55% to 70% of the corresponding length or width of the keycap 110, and the area of the visible region 112 occupies 40% to 55% of the overall area of the top surface of the keycap 110.

The flexible component 120 is deformably disposed between the bottom plate 150 and the keycap 110, and includes a flexible body 122, a rigid member 124, and a second opening 02 corresponding to the visible region 112. The keycap 110 is attached to the flexible body 122 by, for example, adhering or engaging. In addition, in this embodiment, the flexible body 122 is made of rubber for restoring after being pressed and lifting the keycap. The rigid member 124 is bonded to the flexible body 122 for supporting the flexible body 122 and connecting the support structure 130. In this embodiment, the rigid member 124 refers to a material with relatively high hardness or strength relative to the flexible body 122, such as polyoxymethylene (POM), but the rigid member 124 may also be made of polyetherimide (PEI) or other materials with sufficient structural strength. Therefore, the rigid member 124 could be insert-molded with or embedded in the flexible body 122 to form the flexible component 120 in a single-piece.

The support structure 130 includes a third opening 03 corresponding to the visible region 112. The support structure 130 is connected between the bottom plate 150 and the flexible component 120 to keep the keycap 110 horizontal when being moving up and down. The support structure 130 further includes a first connecting member 132 and a second connecting member 134 connected to the first connecting member 132. The first connecting member 132 and the second connecting member 134 include a plurality of shafts 136, and the plurality of shafts 136 are respectively located at two ends of the first connecting member 132 and two ends of the second connecting member 134. A part of the shafts 136 is connected to the bottom plate 150, and another part of the shafts 136 is connected to the rigid member 124. The first connecting member 132 and the second connecting member 134 each have an opening, and the second connecting member 134 is disposed through and pivotally connected to the inner side of the first connecting member 132 to jointly define the third opening 03. In this embodiment, the first connecting member 132 may have a slit connecting the opening thereof on one side close to the bottom plate 150 (as shown in FIG. 2B), thereby facilitating the assembly of the second connecting member 134 into the opening of the first connecting member 132. The support structure 130 is different from the support structure 130P in, for example, configurations and materials. In an embodiment, the third opening 03 of the support structure 130 is larger than the aperture of the support structure 130P in size. Since the support structure 130 has a relatively large third opening 03 in which no flexible component is arranged, a material with relatively high rigidity, toughness, and mechanical strength may be selected as the material of the support structure 130. In this embodiment, the support structure 130 may be made of metal or other engineering plastics, such as nylon 66 (PA66), polyetheretherketone (PEEK), or polyphenylene sulfide (PPS).

As shown in FIG. 2C, to be specific, the rigid member 124 has a first fixing element 126 and a second fixing element 127. For example, the first fixing element 126 is a hook and has a first slot G1. The second fixing element 127 includes two opposite first bosses 128, and a second slot G2 is formed between the two first bosses 128. In addition, the bottom plate 150 has a third fixing element 152 and a fourth fixing element 154. For example, the third fixing element 152 is an L-shaped hook and has a third slot G3, and the fourth fixing element 154 has a hole H1.

The shafts 136 of the first connecting member 132 are connected to the first slot G1 of the first fixing element 126 and the hole H1 of the fourth fixing element 154. The shafts 136 of the second connecting member 134 are connected to the second slot G2 of the second fixing element 127 and the third slot G3 of the third fixing element 152. The keycap 110 stably moves up and down relative to the bottom plate 150 through the support structure 130.

Returning to FIG. 2B, in this embodiment, the circuit layer 140 is disposed between the bottom plate 150 and the flexible component 120, and includes a fourth opening 04 corresponding to the visible region 112. In this embodiment, the pattern modulator 190 includes an electronic paper component 170 and a backlight component 160, is disposed below the bottom plate 150, and includes a pattern region 172 corresponding to the visible region 112 for displaying an electronic pattern. The pattern region 172 is located at the electronic paper component 170. The backlight component 160 is disposed between the electronic paper component 170 and the bottom plate 150. For example, the backlight component 160 has a light source, e.g., a light-emitting diode (LED), for emitting light to illuminate the pattern region 172, so that the pattern displayed by the pattern region 172 is visible even in a case of low ambient brightness. In other embodiments, the pattern modulator 190 may be a display, a liquid crystal display (LCD), an organic light-emitting diode (OLED), or a mini- or micro-LED display component, but the type of the pattern modulator is not limited thereto.

It is worth noting that, as shown in FIG. 1B, the flexible component 122P and the support structure 130P of the second key module 200 occupy the middle region of the second key module 200. If the pattern modulator is disposed in the second key module 200, the pattern modulator may be blocked at least by the flexible component 122P, the first connecting member 132P, and the second connecting member 134P, and cannot be viewed. Comparatively, as shown in FIG. 2A and FIG. 2B, the first opening 01 of the bottom plate 150, the fourth opening 04 of the circuit layer 140, the third opening 03 of the support structure 130, and the second opening 02 of the flexible component 120 overlap at least partially in the pressing direction of the first key module 100, and the pattern region 172 of the electronic paper component 170 is exposed by the first opening 01, the fourth opening 04, the third opening 03, and the second opening 02. In other words, the pattern region 172 is structurally not blocked by the bottom plate 150, the circuit layer 140, the support structure 130, and the flexible component 120, and may be properly viewed from the visible region 112 of the keycap 110. In addition, compared with a conventional key where the pattern is printed on the surface of the keycap, the first key module 100 may change the pattern displayed by the pattern region 172 in real time through software, for example, without replacing the keycap 110 during the process, which is relatively convenient and cost-saving.

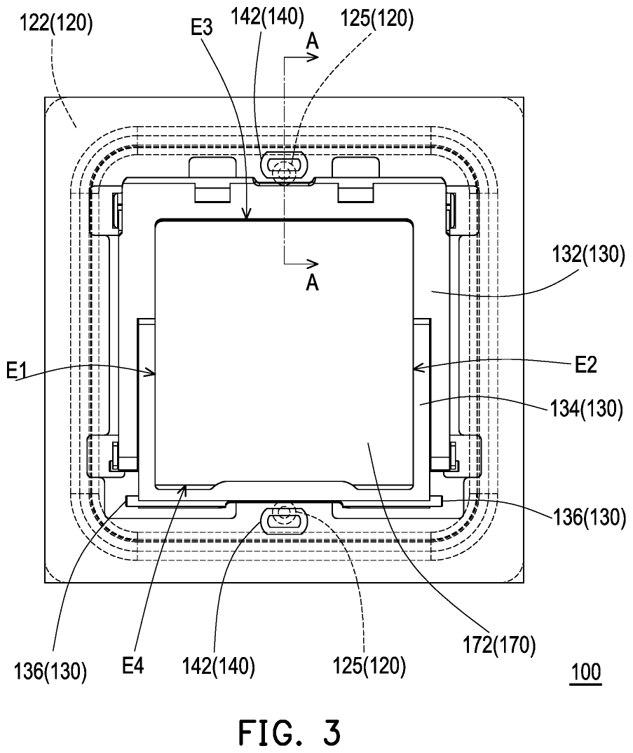

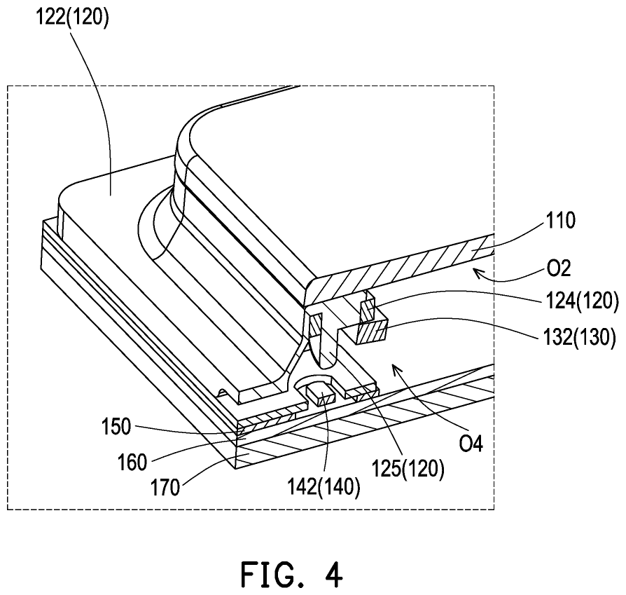

FIG. 3 is a schematic top view of the first key module of FIG. 1A. FIG. 4 is a schematic partial perspective cross-sectional view of the first key module of FIG. 3 along section line A-A. In order to clearly present the internal structure of the first key module, the keycap, the flexible component, and the rigid member are shown with broken lines in FIG. 3. With reference to FIG. 3 and FIG. 4, the pattern region 172 is rectangular and includes a first edge E1 and a second edge E2 opposite to each other and a third edge E3 and a fourth edge E4 opposite to each other. In this embodiment, the circuit layer 140 is a circuit film, and includes at least one trigger switch region 142. The shafts 136 protrude from the first edge E1 and the second edge E2 (for example, the shafts 136 are connected to the fixing elements at the relatively outer side away from the pattern region 172 at the first edge E1 and the second edge E2), the trigger switch region 142 corresponds to at least one of the third edge E3 and the fourth edge E4.

The flexible component 120 further includes at least one pressing portion 125 corresponding to the at least one trigger switch region 142. In this embodiment, the trigger switch region 142 includes a plurality of trigger switch regions, symmetrically disposed beside the fourth opening 04 (FIG. 4); correspondingly, a plurality of pressing portions 125 are symmetrically disposed beside the second opening 02. As a result, projections of the trigger switch region 142 and the pressing portion 125 on the electronic paper component 170 are located outside the pattern region 172, so that the pattern region 172 is not blocked by the trigger switch region 142 and the pressing portion 125.

As shown in FIG. 4, the pressing portion 125 protrudes and extends toward the trigger switch region 142, and the projection of the pressing portion 125 on the circuit layer 140 at least partially overlaps the trigger switch region 142. When the keycap 110 is pressed downward, the flexible body 122 deforms correspondingly, and the pressing portion 125 moves downward and triggers the trigger switch region 142 of the circuit layer 140, accordingly generating an input signal. When the force pressing the keycap 110 downward disappears, the flexible body 122 restores its shape and lifts the keycap 110 upward, and the pressing portion 125 also moves upward away from the trigger switch region 142.

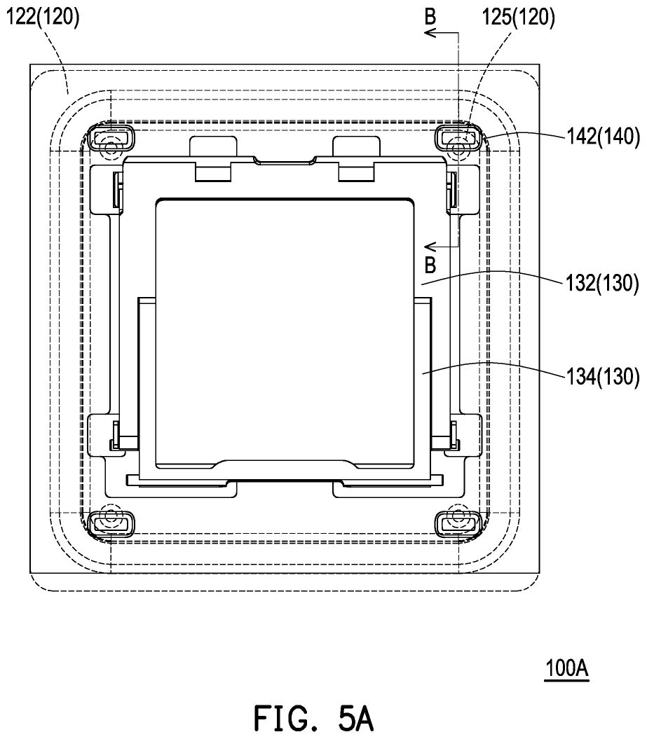

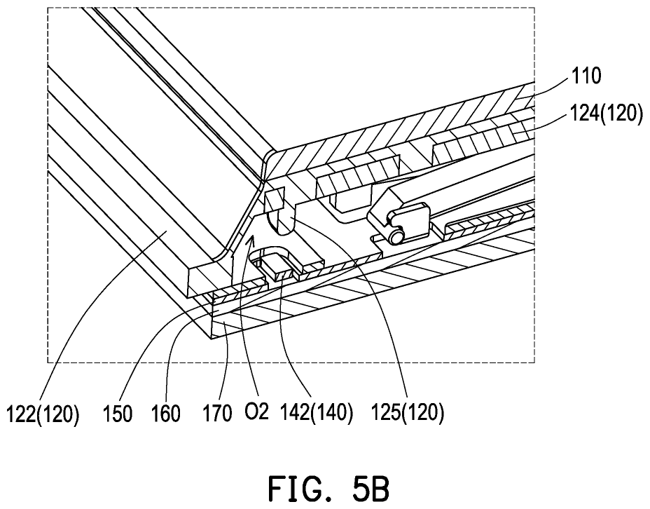

FIG. 5A is a schematic top view of a first key module according to another embodiment of the disclosure. FIG. 5B is a schematic partial perspective cross-sectional view of the first key module of FIG. 5A along section line B-B. In order to clearly present the internal structure of the first key module, the keycap, the flexible component, and the rigid member are shown with broken lines in FIG. 5A. With reference to FIG. 5A and FIG. 5B, the difference between the embodiment shown in FIG. 5A and the embodiment shown in FIG. 3 is that the trigger position of a first key module 100A is the four corners of the circuit layer 140. To be specific, in this embodiment, a plurality of pressing portions 125 are disposed at four corners of the second opening 02 (FIG. 5B), and a plurality of trigger switch regions 142 are correspondingly located at four corners of the fourth opening 04 (FIG. 2B). When the keycap 110 is pressed downward, the pressing portion 125 may move downward to trigger the trigger switch region 142 of the circuit layer 140.

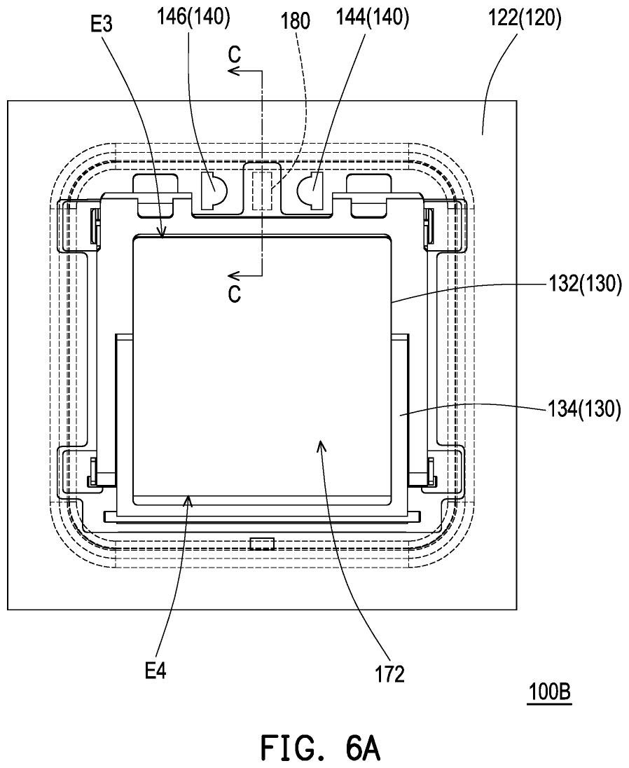

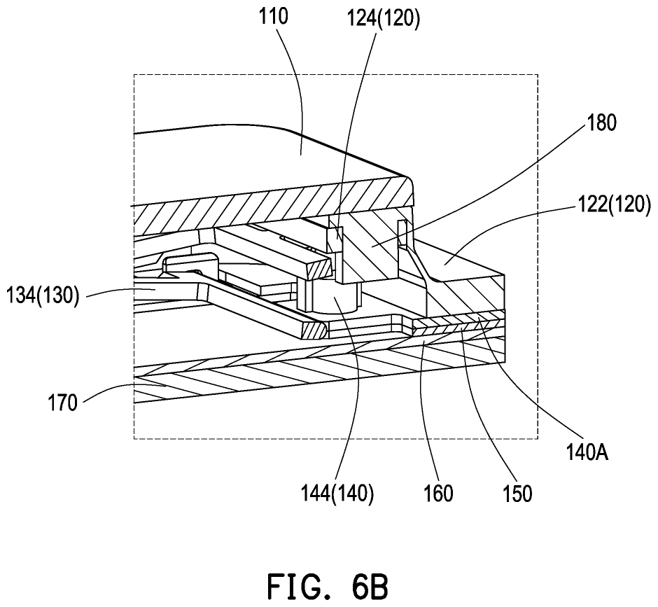

FIG. 6A is a schematic top view of a first key module according to another embodiment of the disclosure. FIG. 6B is a schematic partial perspective cross-sectional view of the first key module of FIG. 6A along section line C-C. In order to clearly present the internal structure of the first key module, the keycap, the flexible component, and the rigid member are shown with broken lines in FIG. 6A. With reference to FIG. 6A and FIG. 6B, the difference between the embodiment shown in FIG. 6A and the embodiment shown in FIG. 2A is that a light emitting component 144 and a light receiving component 146 facing each other are disposed in the circuit layer 140. In other words, a first key module 100B is optically triggered instead of being triggered by a circuit film.

Specifically, the light emitting component 144 and the light receiving component 146 are located at the third edge E3 or the fourth edge E4, and respectively serve to emit and receive light beams. The first key module 100B further includes a blocking portion 180 linked with the keycap 110 (FIG. 6B). The blocking portion 180 is formed at the flexible body 122 and movably inserted between the light emitting component 144 and the light receiving component 146.

When the keycap 110 is pressed downward, the blocking portion 180 moves downward with the flexible body 122 and blocks the light beam emitted by the light emitting component 144, accordingly triggering the circuit layer 140 and generating an input signal. In addition, in this embodiment, since projections of the light emitting component 144, the light receiving component 146, and the blocking portion 180 on the electronic paper component 170 (FIG. 6B) are located outside the pattern region 172, they do not block the electronic pattern displayed by the pattern region 172.

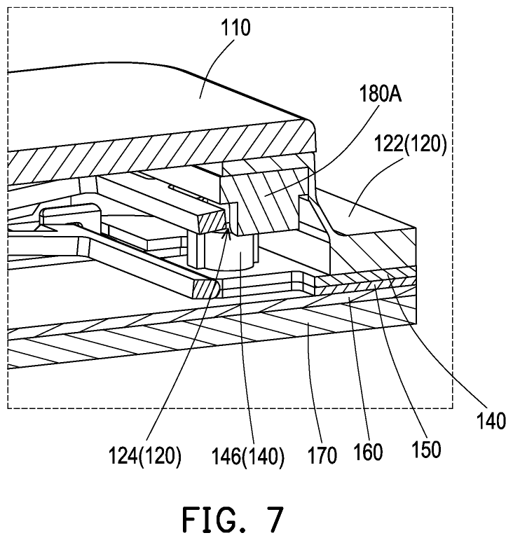

FIG. 7 is a schematic partial perspective cross-sectional view of a first key module according to another embodiment of the disclosure. With reference to FIG. 7, the difference between the embodiment shown in FIG. 7 and the embodiment shown in FIG. 6B is that a blocking portion 180A of FIG. 7 is formed at the rigid member 124. When the keycap 110 is pressed downward, the blocking portion 180A moves downward with the rigid member 124 and blocks the light beam emitted by the light emitting component 144, accordingly triggering the circuit layer 140 and generating an input signal.

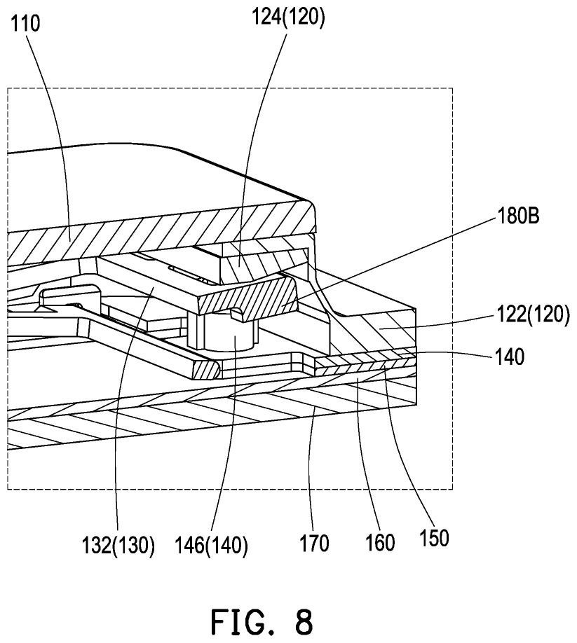

FIG. 8 is a schematic partial perspective cross-sectional view of a first key module according to another embodiment of the disclosure. With reference to FIG. 8, the difference between the embodiment shown in FIG. 8 and the embodiment shown in FIG. 6B is that a blocking portion 180B of FIG. 8 is formed at the support structure 130 (for example, formed at the first connecting member 132). When the keycap 110 is pressed downward, the blocking portion 180B moves downward with the support structure 130 and blocks the light beam emitted by the light emitting component 144, accordingly triggering the circuit layer 140 and generating an input signal.

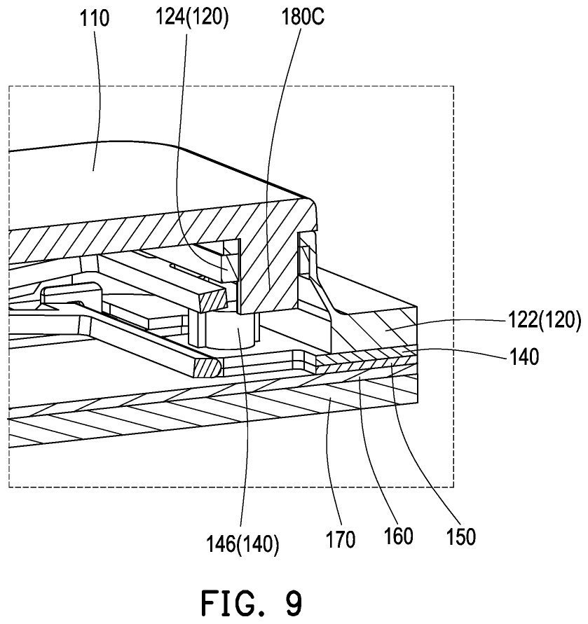

FIG. 9 is a schematic partial perspective cross-sectional view of a first key module according to another embodiment of the disclosure. With reference to FIG. 9, the difference between the embodiment shown in FIG. 9 and the embodiment shown in FIG. 6B is that a blocking portion 180C of FIG. 9 is formed at the keycap 110 and is opaque. When the keycap 110 is pressed downward, the blocking portion 180C moves downward with the keycap 110. Because of being opaque, the blocking portion 180C may block the light beam emitted by the light emitting component 144, accordingly triggering the circuit layer 140 and generating an input signal. Also, since the other parts of the keycap 110 except the blocking portion 180C are transparent, the pattern region 172 (FIG. 2B) of the electronic paper component 170 may be properly viewed.

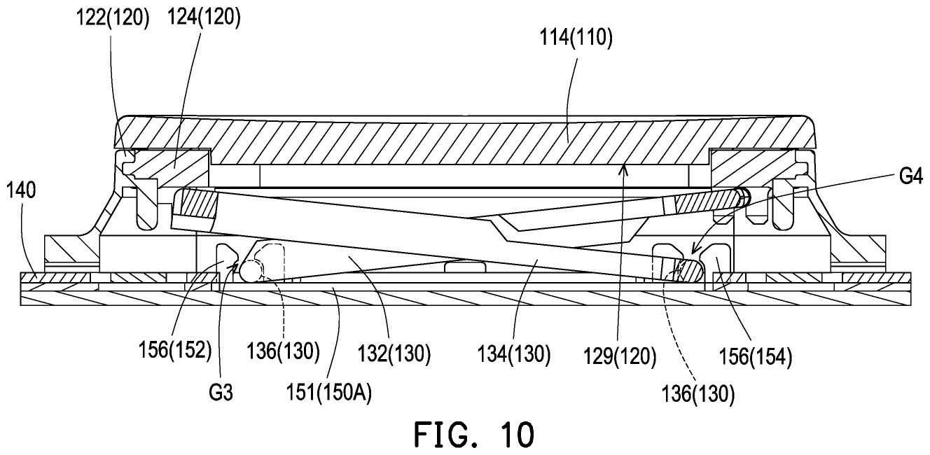

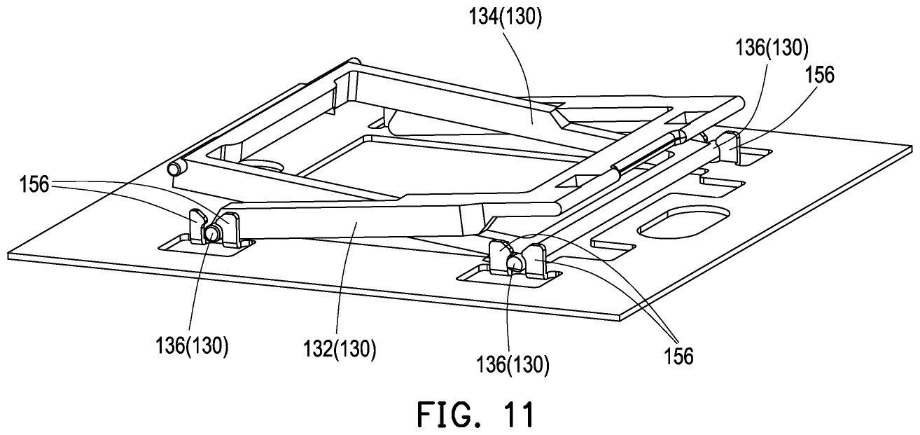

FIG. 10 is a schematic cross-sectional view of a first key module according to another embodiment of the disclosure. FIG. 11 is a schematic perspective view of a support structure and a bottom plate of the first key module of FIG. 10. It should be noted that the third fixing element, the fourth fixing element, and the part of the shaft blocked by the support structure are shown with broken lines in FIG. 10. With reference to FIG. 10 and FIG. 11, the differences between the embodiment shown in FIG. 10 and the embodiment shown in FIG. 2C are that the keycap 110 in FIG. 10 is attached to the rigid member 124, the rigid member 124 extends upward and is flush with the upper surface of the flexible body 122, and the third fixing element 152 and the fourth fixing element 154 of a bottom plate 150A each have two clamping members 156.

To be specific, the keycap 110 has a protruding portion 114, and the rigid member 124 has a recessed portion 129 corresponding to the protruding portion 114. During assembly of the keycap 110 to the rigid member 124, the protruding portion 114 is fitted to the recessed portion 129, so the keycap 110 may be fixed and retained. In addition, the bottom plate 150A includes a flat body 151 and two fixing elements (the third fixing element 152 and the fourth fixing element 154) bent from the flat body 151 and protruding from the flat body 151, and connected to two of the plurality of shafts 136. The third slot G3 is formed between the two clamping members 156 of the third fixing element 152, and a fourth slot G4 is formed between the two clamping members 156 of the fourth fixing element 154. The clamping members 156 are made of metal and are integrally formed with the bottom plate 150A.

The shaft 136 at the lower end of the first connecting member 132 is connected to the third slot G3 of the third fixing element 152 and clamped and fixed by the two clamping members 156, and the shaft 136 at the lower end of the second connecting member 134 is connected to the fourth slot G4 of the fourth fixing element 154 and clamped and fixed by the two clamping members 156. The support structure 130 can be firmly pivoted to the bottom plate 150A through the cooperation between the third fixing element 152 and the fourth fixing element 154.

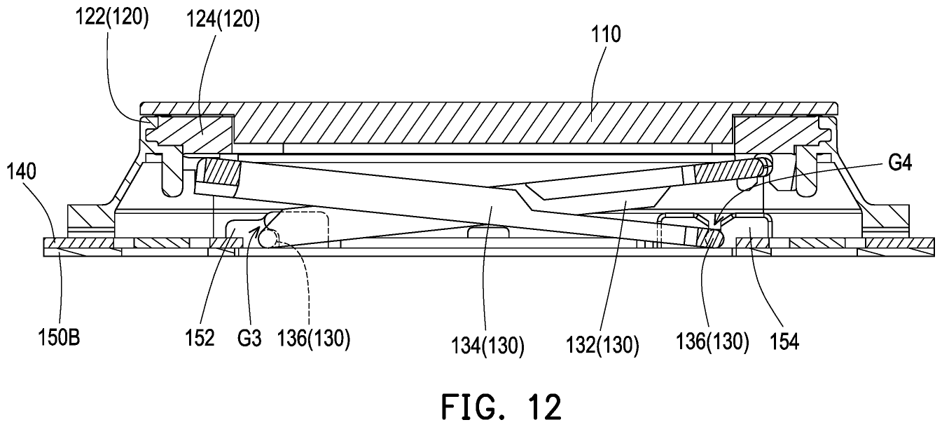

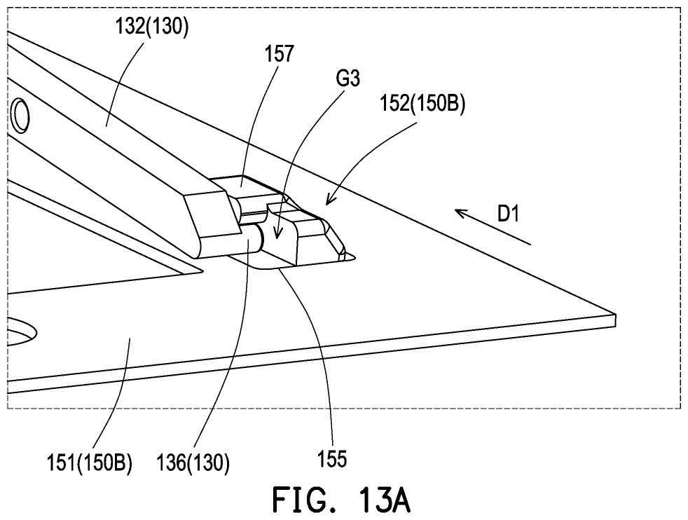

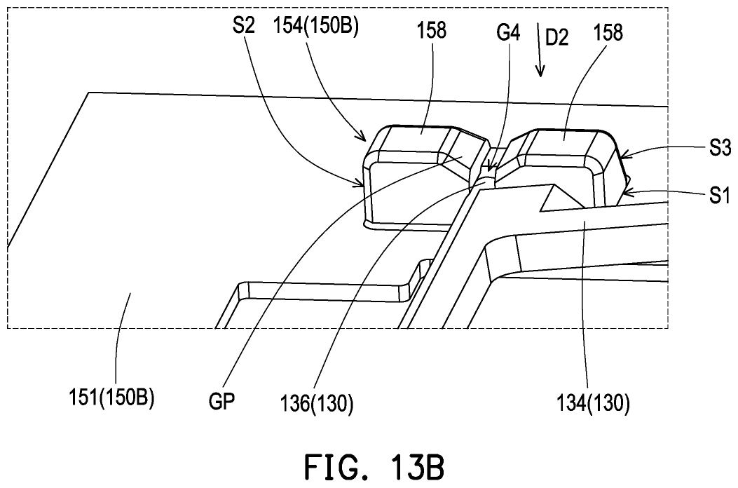

FIG. 12 is a schematic cross-sectional view of a first key module according to another embodiment of the disclosure. FIG. 13A is a schematic partial perspective view of a support structure and a bottom plate of the first key module of FIG. 12. FIG. 13B is another schematic partial perspective view of the support structure and the bottom plate of the first key module of FIG. 12. It should be noted that the third fixing element, the fourth fixing element, and the part of the shaft blocked by the support structure are shown with broken lines in FIG. 12, and the backlight component and the electronic paper component are hidden. The difference between the embodiment shown in FIG. 12 and the embodiment shown in FIG. 10 is that in FIG. 12, the third fixing element 152 is a non-clamping hook and the fourth fixing element 154 is a drop-shaped hook, and the third fixing element 152 and the fourth fixing element 154 are both made of plastic, combined with a bottom plate 150B by insert molding.

As shown in FIG. 13A, specifically, the flat body 151 includes two opening grooves 155, and the fixing elements (the third fixing element 152 and the fourth fixing element 154) are filled in the opening grooves 155 and engaged with the flat body 151. One of the third fixing element 152 and the fourth fixing element 154 includes a slot and a stopping portion. For example, the third fixing element 152 has a third slot G3. The shaft 136 of the first connecting member 132 may slide into the third slot G3 along a first direction D1 and be fixed by a stopping portion 157 of the third fixing element 152. The first direction D1 is parallel to the bottom plate 150B. In addition, as shown in FIG. 13B, the fourth fixing element 154 has two opposite second bosses 158, and the second bosses 158 each have an inclined guide surface GP and surroundingly form a circular slot (the fourth slot G4). The shaft 136 of the second connecting member 134 enters the fourth slot G4 along the inclined guide surfaces GP in a second direction D2, and is clamped and fixed by the two second bosses 158. The second direction D2 is perpendicular to the bottom plate 150B. The support structure 130 can be firmly pivoted to the bottom plate 150B through the cooperation between the third fixing element 152 and the fourth fixing element 154.

In another embodiment of the disclosure, the third fixing element 152 and the fourth fixing element 154 may each be a non-clamping hook (i.e., the third fixing element 152 shown in this embodiment). In yet another embodiment of the disclosure, the third fixing element 152 and the fourth fixing element 154 may each be a water-drop-shaped hook (i.e., the fourth fixing element 154 shown in this embodiment). Nonetheless, the combination of the third fixing element 152 and the fourth fixing element 154 is not limited thereto.

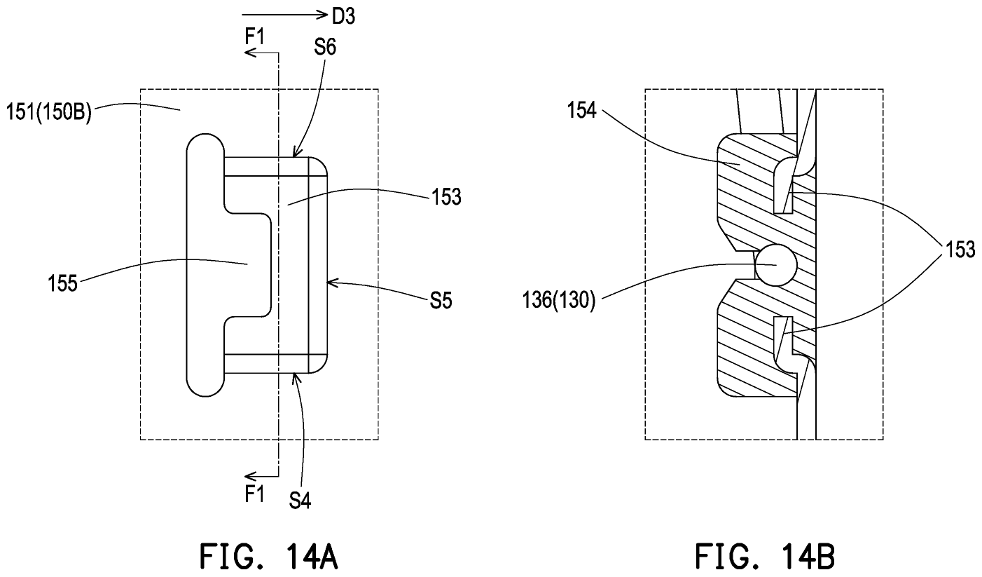

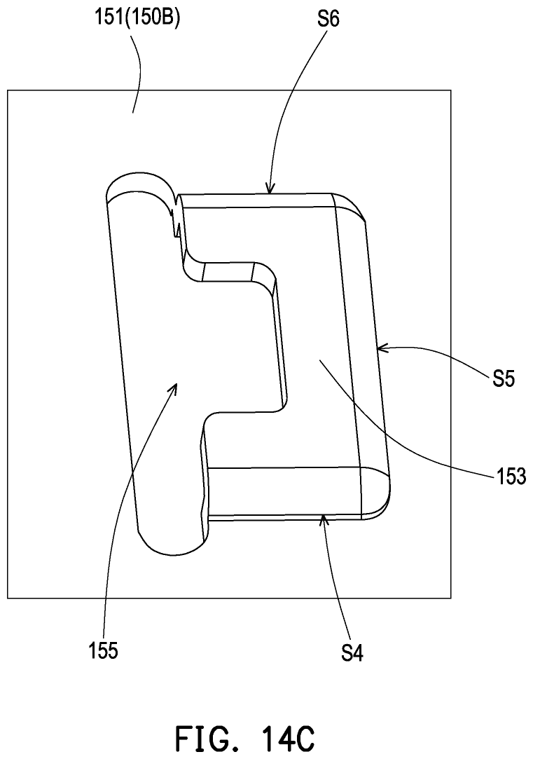

FIG. 14A is a schematic partial top view of the bottom plate of the first key module of FIG. 12. FIG. 14B is a schematic partial cross-sectional view of the first key module of FIG. 14A along section line F1-F1. FIG. 14C is a schematic partial perspective view of the first key module of FIG. 14A. With reference to FIG. 14A to FIG. 14C, in this embodiment, the bottom plate 150B includes two protrusions 153 (with one being shown) beside the two opening grooves 155 (with one being shown) and protruding from the flat body 151. The protrusion 153 and the flat body 151 surroundingly form the corresponding opening groove 155. The protrusion 153 is disposed corresponding to the fourth fixing element 154 of FIG. 13B and the second bosses 158 thereof. In other words, when the plastic fixing element requires a relatively large height, the bottom plate 150B may be provided with a protrusion to increase the structural strength. For example, two sides S4 and S6 of the protrusion 153 are disposed corresponding to two opposite sides S1 and S2 of the second boss 158 of FIG. 13B, and a side S5 of the protrusion 153 is disposed corresponding to a side S3 of the fourth fixing element 154 of FIG. 13B. In addition, taking the fourth fixing element 154 (FIG. 14B) as an example, a part thereof is bonded to the opening groove 155 along a third direction D3 parallel to the flat body 151, and the fourth fixing element 154 wraps the corresponding protrusion 153 to fix the fourth fixing element 154 to the bottom plate 150B.

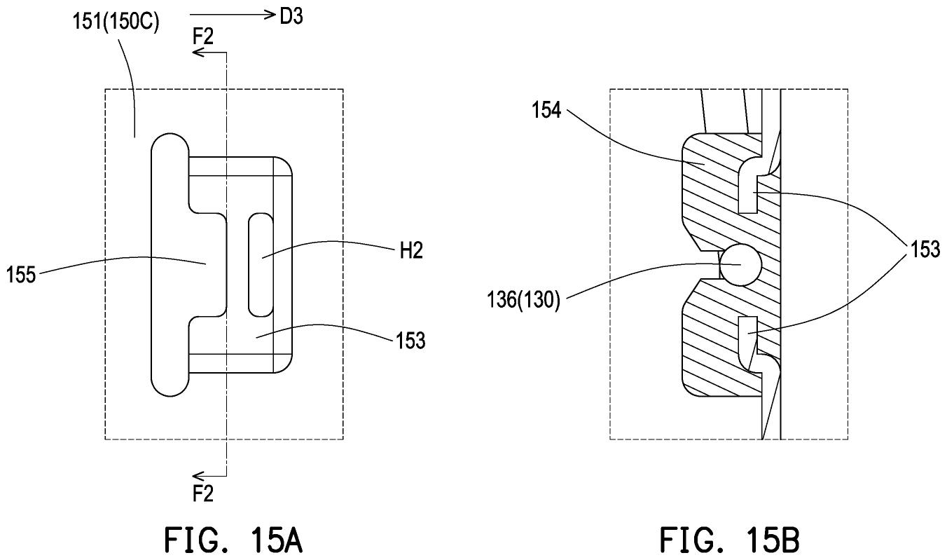

FIG. 15A is a schematic partial top view of a bottom plate of a first key module according to another embodiment of the disclosure. FIG. 15B is a schematic partial cross-sectional view of the first key module of FIG. 15A along section line F2-F2. With reference to FIG. 15A and FIG. 15B, the difference between the embodiment shown in FIG. 15A and the embodiment shown in FIG. 14A is that the protrusion 153 in FIG. 15A has a hole H2. The fourth fixing element 154 (FIG. 15B) is filled in the hole H2 to enhance the combination strength of fixing the fourth fixing element 154 to a bottom plate 150C.

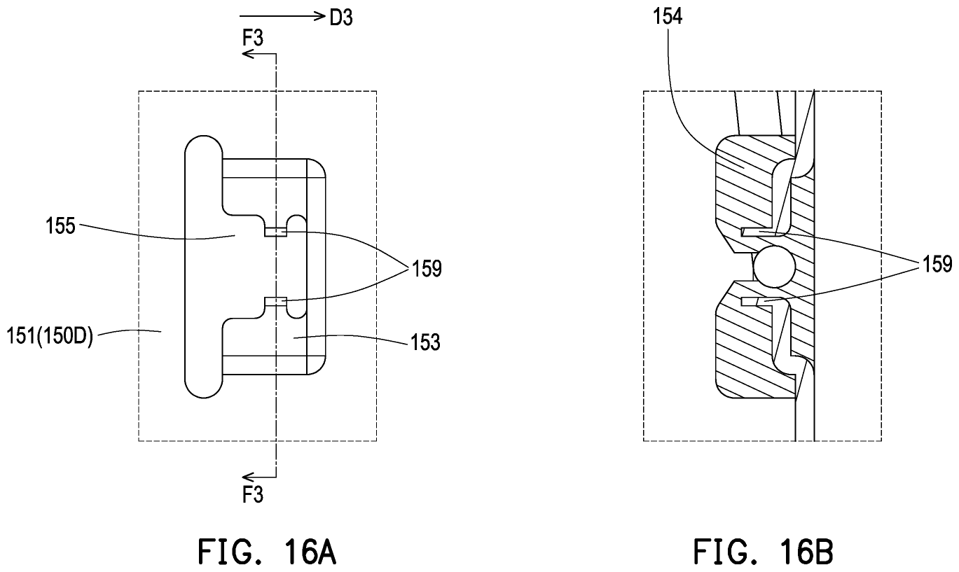

FIG. 16A is a schematic partial top view of a bottom plate of a first key module according to another embodiment of the disclosure. FIG. 16B is a schematic partial cross-sectional view of the first key module of FIG. 16A along section line F3-F3. With reference to FIG. 16A and FIG. 16B, the difference between the embodiment shown in FIG. 16A and the embodiment shown in FIG. 15A is that the protrusion 153 in FIG. 15A has two bent portions 159 opposite to each other, and the bent portions 159 extend in a direction away from the flat body 151. After a part of the fourth fixing element 154 (FIG. 16B) is engaged with the opening groove 155 along the third direction D3, the fourth fixing element 154 wraps the two bent portions 159 to enhance the combination strength of fixing the fourth fixing element 154 to a bottom plate 150D.

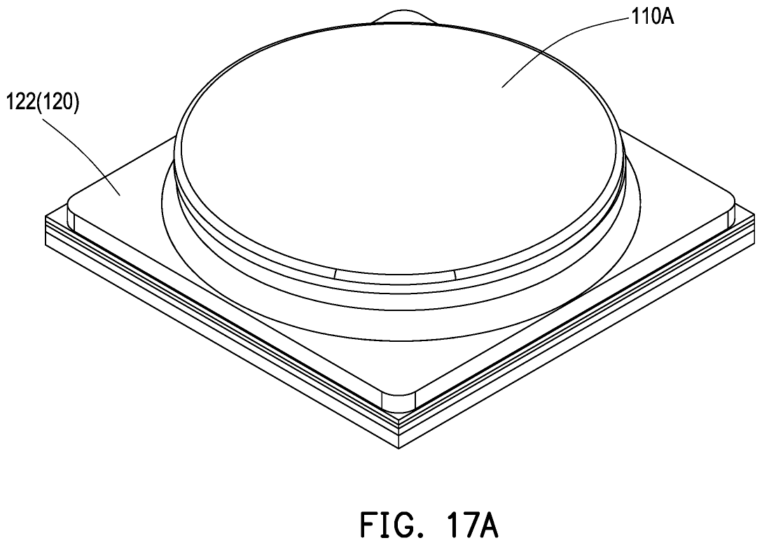

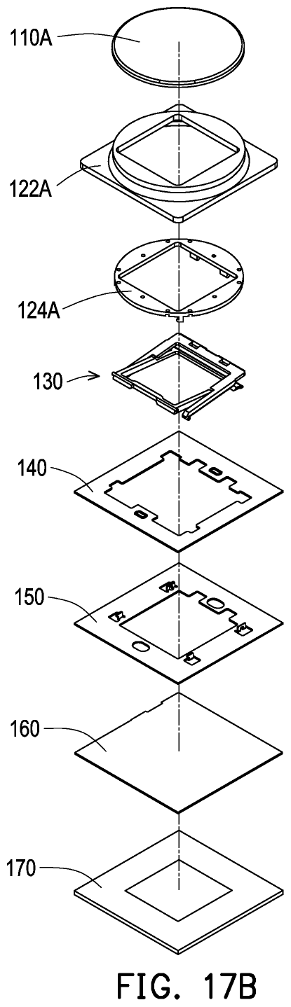

FIG. 17A is a schematic perspective view of a first key module according to another embodiment of the disclosure. FIG. 17B is an exploded view of the first key module of FIG. 17A. With reference to FIG. 17A and FIG. 17B, the difference between the embodiment shown in FIG. 17A and the embodiment shown in FIG. 2A is that the keycap 110 in FIG. 2A is rectangular, while a keycap 110A in FIG. 17A is circular. Nonetheless, the shape of the keycap 110A may also be semi-circular or other shapes, depending on the requirements of the user. In this embodiment, the shapes of a flexible body 122A and a rigid member 124A correspond to the keycap 110A, and the structures and configurations of other components are similar to the embodiment shown in FIG. 2A, and will not be repeatedly described here.

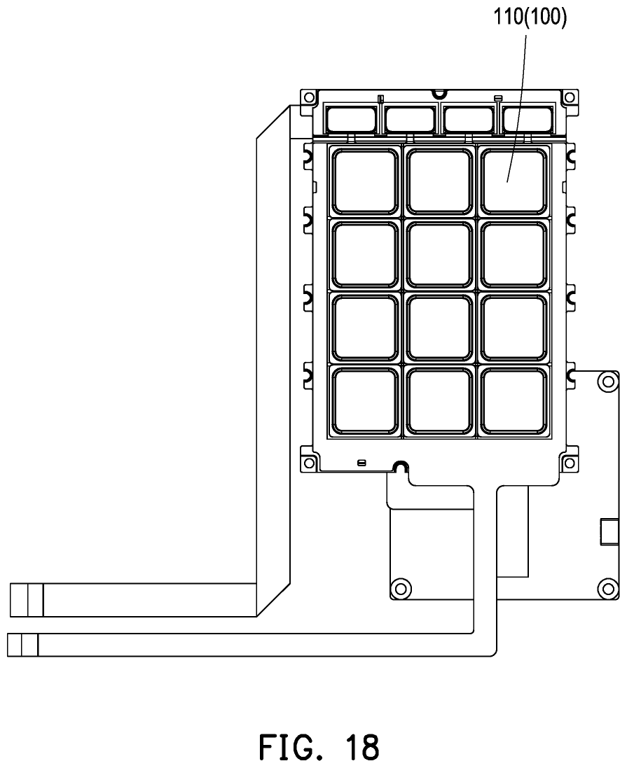

FIG. 18 is a schematic perspective view of a first key module according to another embodiment of the disclosure. With reference to FIG. 18, the difference between the embodiment shown in FIG. 18 and the embodiment shown in FIG. 2A is that the first key module 100 in FIG. 18 is not disposed on the keyboard 10 (FIG. 1). In other words, in this embodiment, the plurality of first key modules 100 may independently form a device, and are not required to be disposed on a keyboard, which is relatively lightweighted and relatively convenient for the user to carry.

The first key module of the embodiment of the disclosure includes a bottom plate, a keycap, a flexible component, a support structure, a circuit layer, an electronic paper component, and a backlight component. Light emitted by the backlight component illuminates the pattern region of the electronic paper component. The pattern region is exposed by the first opening of the bottom plate, the fourth opening of the circuit layer, the third opening of the support structure, and the second opening of the flexible component, and may be viewed from the visible region of the keycap. Since the pattern region of the electronic paper component may change different patterns to be displayed in real time, without replacing the keycap, the user can change the pattern of the first key module quickly and arbitrarily, which is relatively convenient and flexible in use, and cost-saving.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A key module, comprising:
a bottom plate, comprising a first opening;
a keycap, disposed on the bottom plate, and comprising a visible region corresponding to the first opening;
a flexible component, disposed between the bottom plate and the keycap, and comprising a second opening corresponding to the visible region;
a support structure, connected between the bottom plate and the flexible component, and comprising a third opening corresponding to the visible region;
a circuit layer, disposed between the bottom plate and the flexible component, and comprising a fourth opening corresponding to the visible region; and
a pattern modulator, disposed below the bottom plate, and comprising a pattern region corresponding to the visible region.

2. The key module according to claim 1, wherein the pattern modulator comprises:
an electronic paper component, comprising the pattern region corresponding to the visible region; and
a backlight component, disposed on one side of the electronic paper component, so that light emitted by the backlight component illuminates the pattern region.

3. The key module according to claim 1, wherein the circuit layer comprises at least one trigger switch region corresponding to at least one pressing portion of the flexible component, and the at least one trigger switch region and the at least one pressing portion are located outside the pattern region.

4. The key module according to claim 3, wherein the at least one trigger switch region comprises a plurality of trigger switch regions symmetrically disposed beside the fourth opening, and the at least one pressing portion comprises a plurality of pressing portions symmetrically disposed beside the second opening.

5. The key module according to claim 4, wherein the plurality of pressing portions are disposed at four corners of the second opening.

6. The key module according to claim 1, wherein a light emitting component and a light receiving component facing each other are disposed on the circuit layer, a blocking portion linked with the keycap is movably inserted between the light emitting component and the light receiving component, and the light emitting component, the light receiving component, and the blocking portion are located outside the pattern region.

7. The key module according to claim 6, wherein the flexible component comprises a flexible body and a rigid member bonded to the flexible body, and the blocking portion is formed at the flexible body or the rigid member.

8. The key module according to claim 6, wherein the blocking portion is formed at the support structure.

9. The key module according to claim 6, wherein the blocking portion is formed at the keycap, and the blocking portion is opaque.

10. The key module according to claim 1, wherein the flexible component comprises a flexible body and a rigid member bonded to the flexible body, the support structure comprises a plurality of shafts, a part of the plurality of shafts are connected to the bottom plate, another part of the plurality of shafts are connected to the rigid member, the pattern region is rectangular and comprises a first edge and a second edge opposite to each other and a third edge and a fourth edge opposite to each other, the plurality of shafts protrude from the first edge and the second edge, and the light emitting component and the light receiving component are located at the third edge or the fourth edge.

11. The key module according to claim 1, wherein the flexible component comprises a flexible body and a rigid member bonded to the flexible body, and the keycap is attached to the flexible body or the rigid member.

12. The key module according to claim 1, wherein the flexible component comprises a flexible body and a rigid member bonded to the flexible body, the support structure comprises a first connecting member and a second connecting member connected to the first connecting member, the first connecting member and the second connecting member comprise a plurality of shafts, a part of the plurality of shafts are connected to the bottom plate, and another part of the plurality of shafts are connected to the rigid member.

13. The key module according to claim 12, wherein the pattern region is rectangular and comprises a first edge and a second edge opposite to each other and a third edge and a fourth edge opposite to each other, the plurality of shafts protrude from the first edge and the second edge, the circuit layer comprises at least one trigger switch region, and the at least one trigger switch region corresponds to at least one of the third edge and the fourth edge.

14. The key module according to claim 1, wherein the bottom plate comprises a flat body and two fixing elements bent from the flat body and protruding from the flat body, and the fixing elements are respectively connected to the support structure.

15. The key module according to claim 1, wherein the bottom plate comprises a flat body and two fixing elements, the flat body comprises two opening grooves, parts of the two fixing elements are respectively disposed in the two opening grooves and engaged with the flat body, one of the two fixing elements comprises a slot and a stopping portion, one of the plurality of shafts is connected to the slot, the other one of the two fixing elements comprises two opposite bosses, the two bosses each have an inclined guide surface and form a circular slot, and another one of the plurality of shafts is connected to the circular slot.

16. The key module according to claim 15, wherein the bottom plate comprises a protrusion located beside one of the two opening grooves and protruding from the flat body, the protrusion and the flat body form the corresponding opening groove, and the fixing element wraps the corresponding protrusion.

17. The key module according to claim 16, wherein the protrusion has a hole, and the fixing element is filled in the hole.

18. The key module according to claim 16, wherein the protrusion has two bent portions, each of the two bent portions partially extends in a direction away from the flat body, and the fixing element wraps the two bent portions.

19. A keyboard, comprising:
a bottom plate,
a first key module, comprising:
a first keycap disposed on the bottom plate, and comprising a visible region corresponding to a first opening of the bottom plate;
a first flexible component disposed between the bottom plate and the first keycap, and comprising a second opening corresponding to the visible region;
a first support structure disposed between the bottom plate and the first keycap, and comprising a third opening corresponding to the visible region; and
a pattern modulator disposed below the bottom plate, and comprising a pattern region corresponding to the visible region; and
a second key module, comprising:
a second keycap disposed on the bottom plate, and comprising a pattern.

20. The keyboard according to claim 19, wherein the second key module further comprises:
a second flexible component disposed between the bottom plate and the second keycap; and
a second support structure disposed between the bottom plate and the second keycap, wherein the second flexible component is disposed in an aperture of the second support structure.

21. The keyboard according to claim 20, wherein the first support structure is connected between the bottom plate and the first flexible component, and the second support structure is connected between the bottom plate and the second keycap.

22. The keyboard according to claim 20, wherein a size of the third opening of the first support structure is larger than a size of the aperture of the second support structure.
